(19) United States
(12) Patent Application Publication
(10) Pub. No.: US 2008/0060585 A1
(43) Pub. Date: Mar. 13, 2008

(54) Integrated litter box containment system

(76) Inventor: Lynn Ellen Garfield, Cherry Hill, NJ (US)

Correspondence Address: Lynn Ellen Garfield, 322 Browning Lane, Cherry Hill, NJ, 08003, US

(21) Appl. No.: 11/979,086

(22) Filed: Oct. 30, 2007

Related U.S. Application Data
(63) Continuation-in-part of application No. 11/243,800, filed on Oct. 5, 2005.
(60) Provisional application No. 60/619,740, filed on Oct. 18, 2004.

(51) Int. Cl. A01K 29/00

(52) U.S. Cl. 119/165

(57) ABSTRACT

An integrated litter box containment system is disclosed with generally upright elements that functionally increase the height of the litter box thereby serving to better contain animal waste and litter while providing an open top facilitating access for routine removal of waste from the litter. A disposable liner may be fastened to the upright elements thereby providing or enhancing containment or ease of cleaning. The containment system optionally may allow for multiple possible entryways that provide changeable animal access and flexibility in positioning the litter box. The upright elements optionally may be changed from a generally vertical or extended position to a generally horizontal or collapsed position, or be detached for cleaning or storage.

### REFERENCE TO RELATED APPLICATIONS

The present application is a Continuation-in-Part of a prior U.S. patent application Ser. No. 11/243,800, filed on Oct. 5, 2005, and published on May 18, 2006 as United States Published Patent Application 2006012084. Said prior United States Patent Application is entitled to priority benefit of Provisional Patent Application No. 60/619,740, filed on Oct. 18, 2004. Each said prior application in its entirety is hereby incorporated by reference herein to the extent not inconsistent herewith, and all applicable priority benefits thereof are hereby claimed.

### BACKGROUND OF THE INVENTION

1. Field of the Invention

The present invention relates to a litter box for a cat or other animal, and more specifically, to a litter box exhibiting improved waste containment characteristics.

2. Description of Related Art

Some pets, due to their height or where they position themselves within a litter box, eliminate waste over an edge of the litter box, which waste is then deposited outside of the box. Various products have been introduced to address this problem. However, these products have shortcomings rendering them unacceptable to some pet owners.

One of the products available is the covered litter box which consists of a litter box with an enclosure configured to attach to an upper rim of the litter box. This is a detachable enclosure which completely encloses the litter box except for one entrance opening therein. However, it is also known that there are certain problems associated with this type of covered box. The inner walls and bottom rim of the detachable cover can become soiled with waste, and must be cleaned from time to time. The size and shape of the detachable cover make it impractical for pet owners to clean in a standard sized utility sink.

Furthermore, urine can collect in the transitional area where the cover typically rests on the litter box. The collected urine then can leak to the outside of the box through the transitional area, or when the cover is removed for cleaning. Of course, litter within the box should be changed or have the waste scooped out on a regular basis. When a litter box is enclosed by a cover, an extra step of removing the cover is required to scoop waste out of the litter. If the cover is clamped to the frame, some of the clamping devices may be difficult to disengage. So, covered litter box maintenance can be cumbersome as well as physically challenging, and both of these attributes are significant deterrents to scooping waste out of the litter on a regular basis.

Still further, with the cover on the box, one cannot readily determine if there is waste to be scooped out. The lack of this visual reminder can also be a deterrent to scooping the litter regularly. Cats are sensitive to odor and the concentrated odor contained within a covered litter box can be offensive to some cats to such degree that they stop using the litter box.

Tall or large cats may find the covered box too confining, and some pets for unknown reasons are reluctant to enter the fully closed space. Another disadvantage of the covered litter box is that because the location of the litter box entryway is fixed, and because the cover is rather high, there are limitations as to where the covered litter box can be placed and oriented due to obstacles and space constraints commonly encountered in domestic surroundings.

Another known litter box configuration is one with relatively tall, permanently attached sides. Similar to the covered litter box discussed above, the bulky shape of a high-sided box does not afford easy cleaning in a standard sized utility sink. Some of these high-sided litter boxes include an entry opening into the box which is higher than an average rim for the animal to step over. This can be a barrier for young, small, injured, older, and less agile pets.

Another known litter box configuration is similar to the covered litter box discussed above, but with a large hole in the top through which an animal must jump or climb to enter the litter box since no other entryway is provided. This can be a very significant barrier for young, small, injured, older, and less agile pets. Also, this configuration does not afford easy cleaning if the cover is left in place, and otherwise has the same disadvantages as the covered litter box discussed above.

Still another product on the market has a detachable lip or ledge for catching stray litter. The lip structure locks onto an upper rim of a litter box and extends horizontally a few inches outwardly from the rim. This attachment does not extend the sides vertically to effectively prevent waste from overshooting the litter box.

Efforts to overcome the issue of waste leakage, litter overspill, and other problems discussed above have fallen short of an ideal solution. There exists a need to provide an apparatus configured to prevent animal waste and litter from escaping the litter box; while also facilitating easy cleanup and maintenance, flexible orientation, and side-barrier protection, even to a relatively low-sided litter box; and while avoiding discouraging the pet's use of the litter box due to confined overhead space, concentrated odors, or difficult access.

### BRIEF SUMMARY OF THE INVENTION

The present invention presents a solution alleviating the problems mentioned above. This unique solution comprises a litter box as a lower component integrated with a generally open-topped integrated containment system that forms a waste and litter barrier upper component. The containment system incorporates an essentially upright element or elements extending above the upper rim of the litter box. A disposable liner, manufactured from a fluid impermeable, pliable material such as plastic or vinyl can be used in conjunction with or as a component of the essentially upright element or elements. The essentially upright element or elements are referred to below more simply as the “upright elements.” The upright elements effectively raise the litter box sides or periphery preventing animal waste and litter distribution beyond the perimeter of the litter box, whether through the intended use of the litter box, or by the action of an animal digging vigorously in the litter.

The lower component of the integrated litter box containment system may be generally of any shape suitable to hold litter for use by an animal, such as a generally open box or pan. The integrated litter box containment system may be fashioned as a single, unitary piece, or as multiple separate pieces that interconnect, interlock, fasten, or otherwise fit together. The upright elements may be fixed in position or be adjustable, whether by being changeable in orientation or in position along the rim of the litter box, or by being otherwise physically alterable. This includes that the upright elements may be constructed in a manner to be permanently fixed in a generally upright position; or may be foldable, collapsible, detachable, or otherwise amenable to being changed from a secured, generally upright position to a more generally horizontal or low profile position. The resulting alterable configuration facilitates shipping, storage, placement, manipulation, and cleaning of the litter box. The upright elements, if folded, collapsed, or detached, do not interfere with cleaning the litter box in a small utility sink.

One possible embodiment of the present invention incorporates a liner that generally covers an inner surface of the litter box, including an inner surface of the upright elements, and extends below said upper rim of the litter box. The liner attaches to, or is otherwise supported by, the upright elements, and helps to contain solid and liquid waste, and also litter, within the litter box.

A liner can keep the upright elements clean, and can complete or complement the side barrier to contain waste within the litter box. Attachment devices securing said liner may be any suitable known means of attachment such as, but not limited to, clamps, spring clips, magnetic fasteners, tethered bullet nosed fasteners, adhesive strips, tape, hook and loop material fasteners, or hooks.

The liner also may be formed to drape over the top of the upright elements. A liner can provide at least one area which may be formed into an entry opening, such as a perforated area. A liner also may incorporate one or more preformed openings that can be left open, or can be closed, such as by sealing a flap with an adhesive strip or tape.

The present invention, in certain embodiments, provides an optionally relocatable entryway. A relocatable entryway allows the litter box to be oriented to suit household surroundings or the needs of the pet.

Another aspect of the present invention is to provide a generally open top to allow easy access for routine removal of waste from the litter. The open top of the invention also allows the litter box to be placed where a covered box would not fit, for example under a sink where a drain pipe might interfere with placement of a covered litter box. The open top also provides a litter box with side barrier protection that does not confine the pet beneath a cover while using the litter box, and does not confine odors to the area within the box which may discourage the pet's use of the box.

Since the present invention can incorporate any size litter box, spaces commanding a relatively small litter box, such as would be the case in a shelter cage, can enjoy the advantages of a litter box with an integrated containment system that provides augmented side-barrier protection. For small or injured animals requiring a low-sided litter pan for ease of access, the integrated containment system offers a simple and elegant solution since it does not add height to the entry opening.

One embodiment of the present invention incorporates a litter box manufactured from a resilient plastic material and having a substantially upright element in each corner thereof. In this embodiment these elements have fasteners which may be used to attach a pliable fluid impermeable disposable liner. Side barrier protection is provided by this disposable liner covering the inner surfaces of the upright elements and extending along an interior surface of the litter box. Further, an opening is afforded between two of the generally upright elements as an entryway.

Other aspects of the present invention will become apparent from the following detailed description and accompanying drawings. It is to be understood, however, that the drawings are intended solely for purposes of illustration and not as a definition of the limits of the invention, for which reference should be made to the appended claims.

### BRIEF DESCRIPTION OF THE DRAWINGS

The invention will be best understood by reference to the following detailed description of illustrative embodiments when read in conjunction with the accompanying drawings, wherein:

FIG. 1A is a perspective view of an embodiment of the claimed invention comprising a litter box with attached foldable upright elements shown secured in a generally upright position and including a liner in attached position on the upright elements;

FIG. 1B is a perspective view of the embodiment of FIG. 1A with the attached foldable upright elements shown in lowered position for cleaning or storage;

FIG. 2A shows a perspective view of the claimed invention where collapsing upright elements are shown in a telescopically extended, generally upright position, and with a liner attached the upright elements;

FIG. 2B illustrates a perspective view of the embodiment in FIG. 2A with said liner removed, and with the telescoping or otherwise collapsible upright elements in lowered, collapsed position;

FIG. 3A is a perspective view of still another embodiment of the claimed invention comprising a litter box with substantially hollow generally cylindrical receptacles or passages along the upper rim of the litter box configured to secure therein generally upright elements to which a liner is attached;

FIG. 3B depicts a perspective exploded view of the embodiment in FIG. 3A with one generally upright element depicted as detached;

FIG. 4A is a perspective exploded view of still another form of the claimed invention comprising a litter box with slots defined in the upper rim of the litter box and a generally upper element comprising substantially solid walls and flanges configured to engage with said slots;

FIG. 4B illustrates a perspective view of the embodiment in FIG. 4A shown with the upper component engaged with the upper rim of the litter box and incorporating fastening clips configured to secure a liner;

FIG. 5A is a perspective exploded view of another embodiment of the claimed invention comprising a litter box with openings in the upper rim and an upper component incorporating relatively narrow, generally upright elements in the form of posts joined together by relatively low, generally horizontal elements with flanges configured to fit into the rim openings;

FIG. 5B presents a perspective view of the embodiment in FIG. 5A with the containment system engaged in the upper rim of the litter box and supporting a liner.

### DETAILED DESCRIPTION OF THE INVENTION

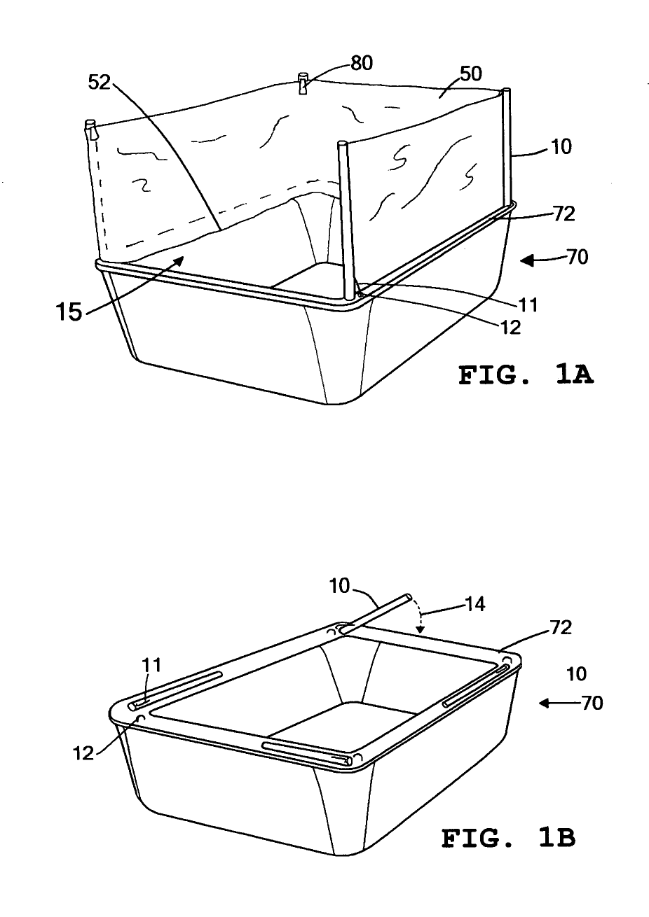

Illustrated in FIG. 1A is an embodiment of the present invention wherein litter box 70 is integrated with attached foldable upright elements 10 shown in a secured generally upright position and extending above upper rim 72 of litter box 70. Each said upright element 10 has a latch depicted schematically at 11 which can be engaged into a hook, also depicted schematically at 12. These interconnecting latch elements 11 and 12 serve to secure the element 10 in an upright position. Each upright element 10 has a fastener 80.

Also illustrated in FIG. 1A, liner 50 extends generally downward from fasteners 80 along an inner surface of upright elements 10 and litter box 70. All but one side of litter box 70 is substantially lined by liner 50, thus affording an entryway 15 through the one open side. Bottom edge 52 of liner 50 extends below the upper rim 72 of litter box 70 in order to contain waste and litter within litter box 70.

Illustrated in FIG. 1B is an embodiment of the present invention wherein litter box 70 with attached upright elements 10 are folded relatively flat against upper rim 72 of litter box 70. Elements 10 can be secured in a generally upright position, as shown in FIG. 1A, or collapsed as depicted by reference character 14 into a substantially flattened position. Each latch 11 can be disengaged from its corresponding hook 12 to enable upright element 10 to be folded down. Of course, any equivalent latching connectors may be utilized, including friction detents, rotary latches, under or over center latches, lockable recessed hinge elements, and so on.

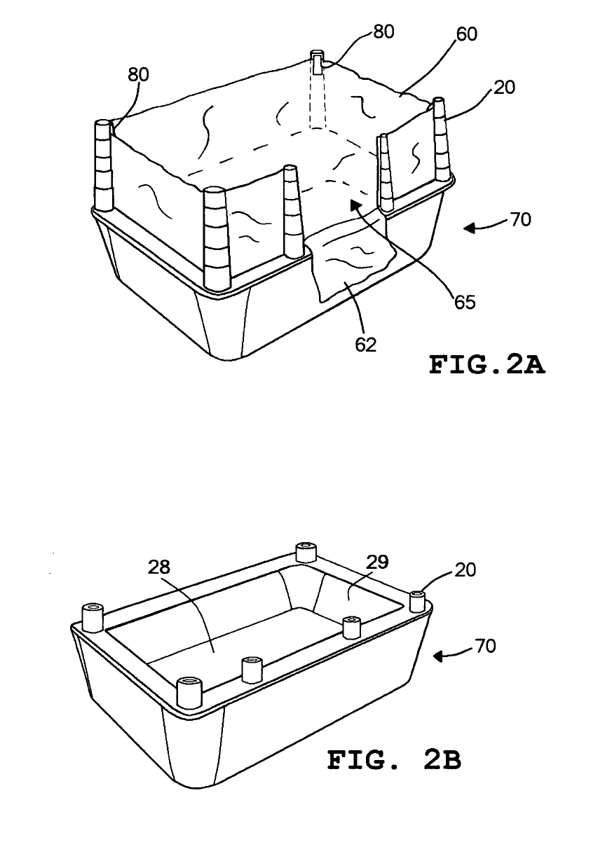

Illustrated in FIG. 2A is an embodiment of the claimed invention including removable liner 60 substantially covering an interior surface of litter box 70 and extending upward so as to be secured by fasteners 80 on a plurality of attached collapsible upright elements 20 shown herein in a fully extended, telescoped position. The upright elements 20 are held in their extended mode by means of a frictional interference fit typical of such telescoping and collapsing units. Liner 60 has an opening 65 formed by flap 62 which is folded down to allow entry into litter box 70.

FIG. 2B illustrates a perspective view of the embodiment in FIG. 2A with the liner 60 removed, upright elements 20 collapsed into a lowered position for easier cleaning or storage of litter box 70, and depicting an interior bottom surface 28 and an interior side surface 29.

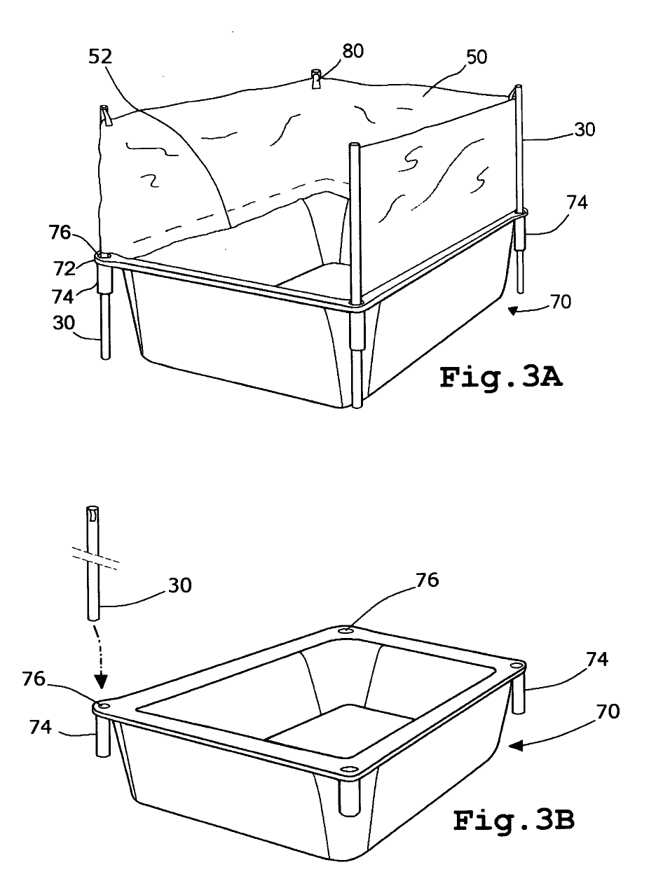

The embodiment of the claimed invention shown in FIG. 3A depicts litter box 70 with openings 76 in upper rim 72 of litter box 70. Bottoms of upright elements 30 are inserted into openings 76 so that they pass through and are secured by mating with receiving element 74 positioned beneath openings 76. A liner 50 is attached to fasteners 80 on a plurality of upright elements 30. The bottom edge 52 of the liner 50 extends below the upper rim 72 of the litter box 70 in order to contain waste and litter within litter box 70.

In FIG. 3B is illustrated a perspective exploded view of the embodiment in FIG. 3A with liner 50 and several upright elements 30 removed. A single upright element 30 is shown aligned with an opening 76 for insertion into a receiving element 74 of litter box 70.

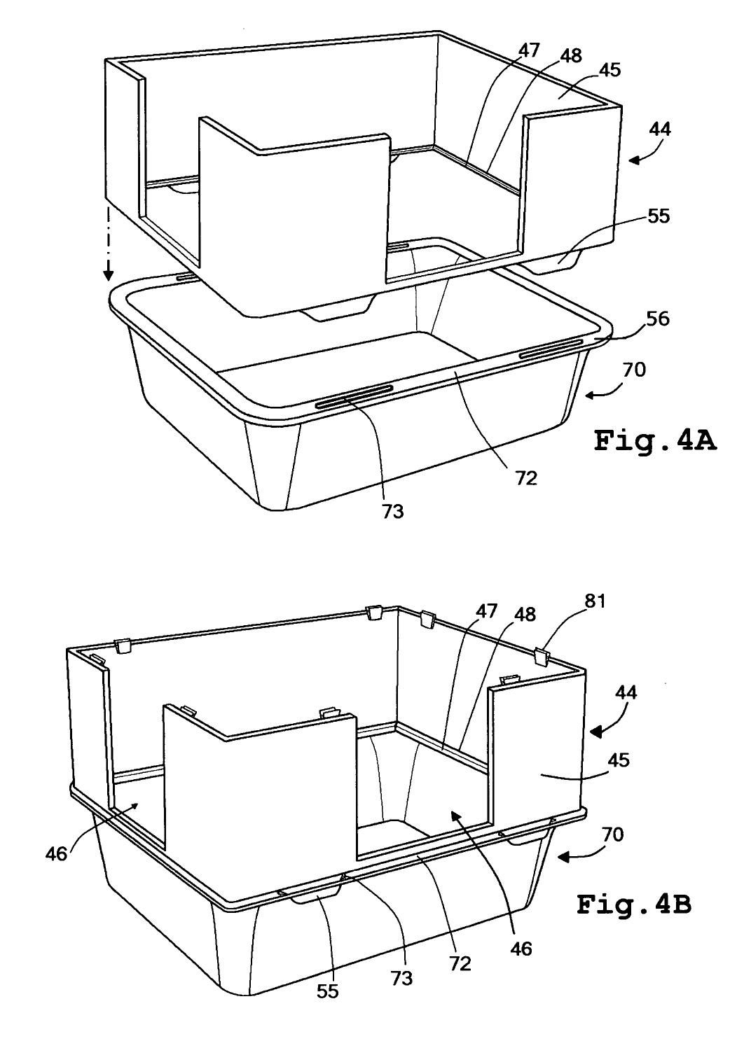

FIG. 4A illustrates a perspective exploded view of an embodiment of the claimed invention wherein the upper component of the containment system 44 is configured in the form of solid walls 45. The upper rim 72 of litter box 70 incorporates openings 73 configured to engage with flanges 55 incorporated into upper component 44. The solid walls 45 have a lip 47 that extends downward from the inner bottom surface 48 of solid walls 45.

Walls 45 may be generally continuous as illustrated in FIG. 4A, or comprised of individual partial wall upright elements without departing from the spirit and scope of the claimed invention. Similarly, within the scope of the depending claims, flanges 55 and rim openings 73 could be reversed in position such that the flanges are, instead, on the rim; and the openings formed in a mating portion of the containment system are essentially located where flanges 55 are shown in FIG. 4A.

The perspective view depicted by FIG. 4B illustrates the embodiment in FIG. 4A with the upper component of the containment system 44 engaged on rim 72 of litter box 70 by insertion of flanges 55 into rim openings 73. Positioned along the upper edge of the substantially solid walls 45 are clips 81 that can be used to secure a liner (not shown, but essentially identical to the liners earlier discussed herein). Substantially solid walls 45 incorporate openings 46, one of which could be covered by a liner (not shown), with the other left open providing an entryway. The lip 47 of solid walls 45 extends below the inner surface of upper rim 72 of litter box 70 to block liquid waste from leaking outside the litter box 70 through the transitional area between the upper component 44 and the litter box rim 72.

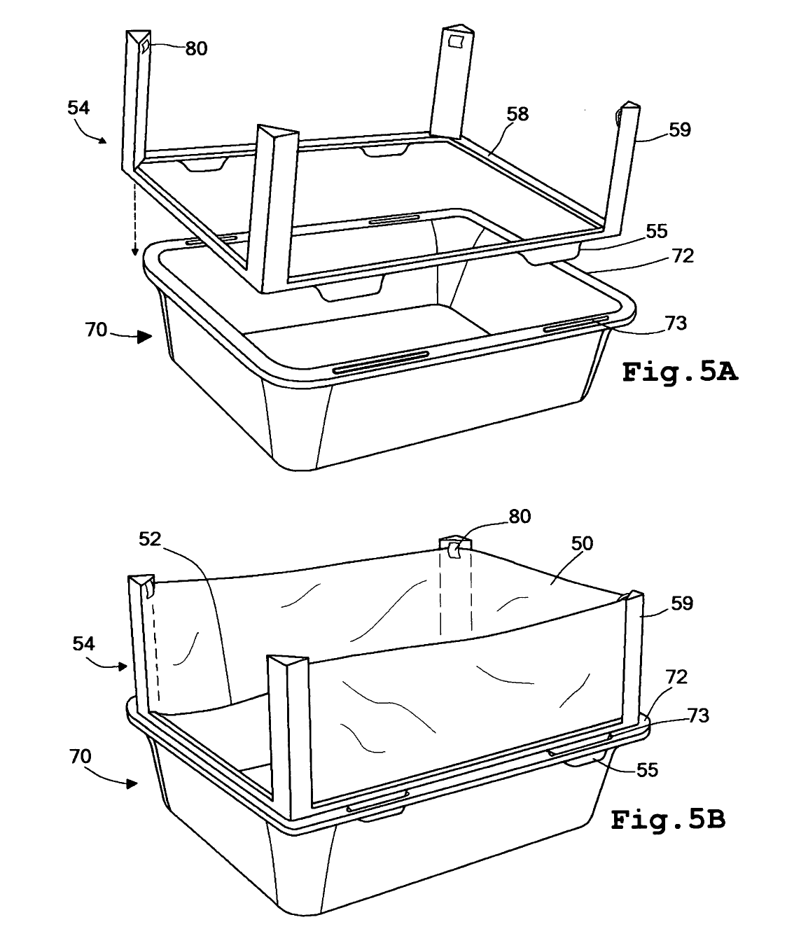

FIG. 5A illustrates a perspective exploded view of an embodiment of the claimed invention comprising litter box 70 with openings 73 in rim 72 and a configuration of the upper component of containment system 54 incorporating narrow generally upright elements 59 joined together by relatively low and generally horizontal elements 58 with flanges 55 fitting into rim openings 73. Here again, the physical cooperative relationship of flanges 55 and openings 73 may be reversed as a matter of design.

FIG. 5B illustrates a perspective view of the embodiment in FIG. 5A wherein the upper component of containment system 54 is depicted as engaged on rim 72 of litter box 70, for example, by insertion of the flanges 55 into the rim openings 73. Liner 50 is attached to generally upright elements 59 by means of fasteners 80. The bottom edge 52 of liner 50 extends below upper rim 72 of the litter box 70 in order to contain waste and litter within litter box 70.

Although the present invention has been depicted in various forms in the foregoing detailed description and as illustrated in the accompanying drawings, it will be understood that the invention is in no way limited to the embodiments disclosed, but may assume numerous arrangements, rearrangements, modifications, and substitutions of features without departing from the spirit of the invention.

What is claimed is:

1. An integrated litter box containment system comprising:
an animal litter box element, as a lower component of the containment system, configured to have an interior defined by side and bottom surfaces, and an upper rim that substantially surrounds said interior and defines a perimeter;
one or more elements, as an upper component of the containment system, that extend above said upper rim, configured to leave a substantially open top, to provide a barrier substantially surrounding said perimeter, and to facilitate use of a liner fastened to or otherwise supported by said elements; and
at least one entryway located at one or more sides of the containment system configured to allow access to said interior by an animal;
whereby said upper component and said lower component are configured in an integrated manner to contain waste and other matter within said containment system.

2. The litter box containment system of claim 1, wherein said elements that extend above said upper rim are fixed in position.

3. The litter box containment system of claim 1, wherein said elements that extend above said upper rim are adjustable in position, including being adjustable in location, orientation, or extension.

4. The litter box containment system of claim 3, further having means for locking or securing said elements that extend above said upper rim at a particular position.

5. The liter box containment system of claim 1, wherein said elements that extend above said upper rim are removable from said litter box.

6. The litter box containment system of claim 5, further having means for affixing or securing said elements that extend above said upper rim to said litter box element.

7. The litter box containment system of claim 1, wherein said liner is fastened to or otherwise supported by said elements that extend above said upper rim, said liner configured and disposed to extend to a position generally below said upper rim of said litter box element.
